(19) United States
(12) Patent Application Publication
(10) Pub. No.: US 2017/0057545 A1
(43) Pub. Date: Mar. 2, 2017

(54) GPS DATA CORRECTION FOR AUTOMATED VEHICLE

(71) Applicant: DELPHI TECHNOLOGIES, INC., TROY, MI (US)

(72) Inventors: MICHAEL H. LAUR, MISSION VIEJO, CA (US); LUDONG SUN, STANFORD, CA (US); INDU VIJAYAN, SUNNYVALE, CA (US); JAN K. SCHIFFMANN, NEWBURY PARK, CA (US)

(21) Appl. No.: 14/835,798

(22) Filed: Aug. 26, 2015

(51) Int. Cl. B62D 15/02; G01S 13/93; G05D 1/02

(52) U.S. Cl. CPC B62D 15/0265; G05D 1/0231; G01S 13/931; G05D 1/0278; G01S 2013/9342; G01S 2013/9357

(57) ABSTRACT

A system for automated operation of a host-vehicle includes an object-sensor, a global-positioning-system (GPS) receiver, and a controller. The object-sensor is used to determine a first-polynomial indicative of a preferred-steering-path based on an object detected proximate to a host-vehicle. The GPS-receiver is used to determine a second-polynomial indicative of an alternative-steering-path based on a GPS-map. The controller is configured to steer the host-vehicle in accordance with the first-polynomial when the object is detected, and steer the host-vehicle in accordance with the second-polynomial when the object is not detected. The improvement allows the system to make use of a less expensive/less accurate version of the GPS-receiver, and a less complicated GPS-map than would be anticipated as necessary for automated steering of the host-vehicle using only the GPS-receiver and the GPS-map.

### TECHNICAL FIELD OF INVENTION

This disclosure generally relates to a system for operating automated vehicles, and more particularly relates to a system that aligns or transforms GPS-data and available map-data with a travel path of a host-vehicle so the map-data can be used for steering the host-vehicle if adequate objects (e.g. lane-markings) for steering the vehicle are not detected.

### BACKGROUND OF INVENTION

Systems for automated operation of a host-vehicle that steer the host-vehicle in accordance with the detection of objects (e.g. lane-markings, curbs, roadway-edges) are known. However, if the host-vehicle is navigating through a construction zone where all of the objects have been removed, or the presence of snow has covered or obscured the objects, the detection of objects may not be a feasible means of steering the host-vehicle. It has been suggested that high-definition map-data and a high-precision global-positioning-system (GPS) receiver with centimeter position resolution could be relied upon to steer the host-vehicle. However, the expense of such receivers and the amount of data necessary for such a scheme make this option undesirable. What is needed is a way to make use of lower-precision GPS-receivers and already available lower-resolution map-data to steer the host-vehicle when steering by object detection is not feasible.

### SUMMARY OF THE INVENTION

In accordance with one embodiment, a system for automated operation of a host-vehicle is provided. The system includes an object-sensor, a global-positioning-system-receiver (GPS-receiver), and a controller. The object-sensor is used to determine a first-polynomial indicative of a preferred-steering-path based on an object detected proximate to a host-vehicle. The GPS-receiver is used to determine a second-polynomial indicative of an alternative-steering-path based on a GPS-map. The controller is configured to steer the host-vehicle in accordance with the first-polynomial when the object is detected, and steer the host-vehicle in accordance with the second-polynomial when the object is not detected.

Further features and advantages will appear more clearly on a reading of the following detailed description of the preferred embodiment, which is given by way of non-limiting example only, and with reference to the accompanying drawings.

### BRIEF DESCRIPTION OF DRAWINGS

The present invention will now be described, by way of example with reference to the accompanying drawings, in which:

FIG. 1 is a diagram of a system for automated operation of a host-vehicle in accordance with one embodiment;

FIG. 2 is top-view of a roadway traveled by the host-vehicle equipped with the system of FIG. 1 in accordance with one embodiment; and

FIG. 3 is a zoomed-in view of the roadway of FIG. 2 in accordance with one embodiment.

### DETAILED DESCRIPTION

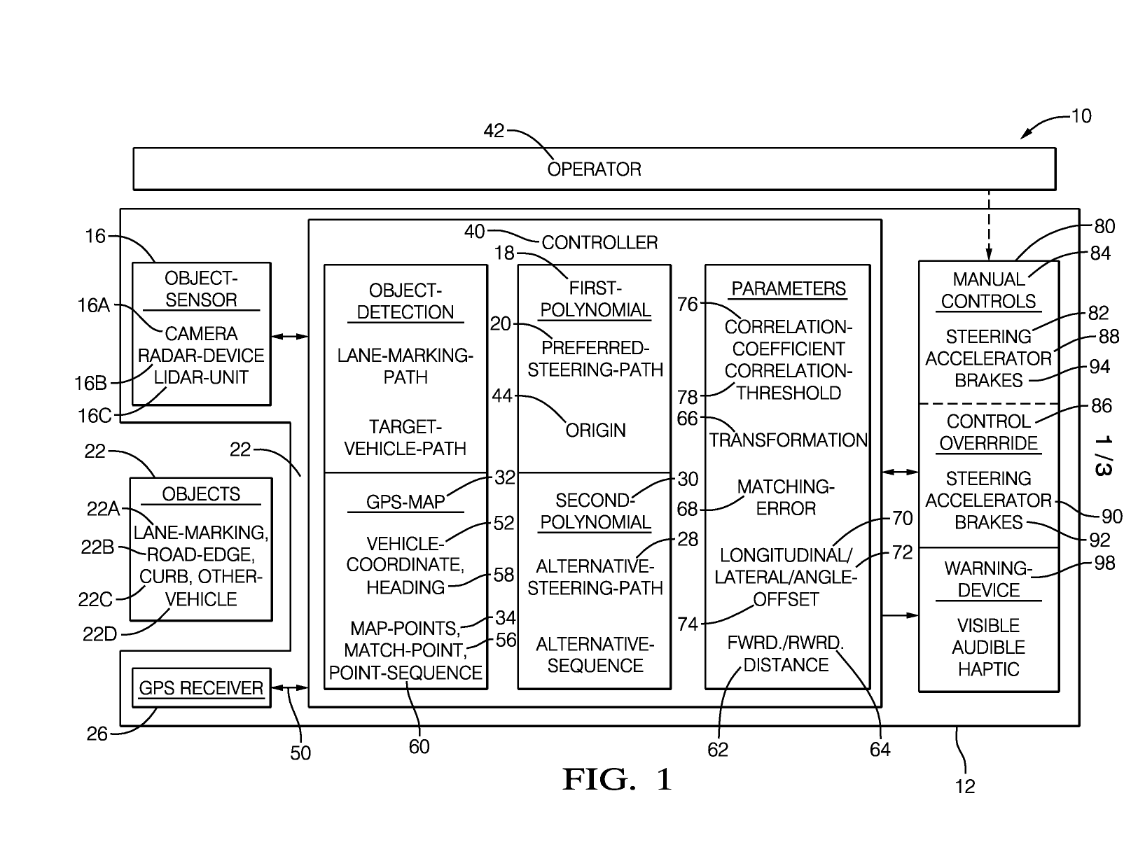

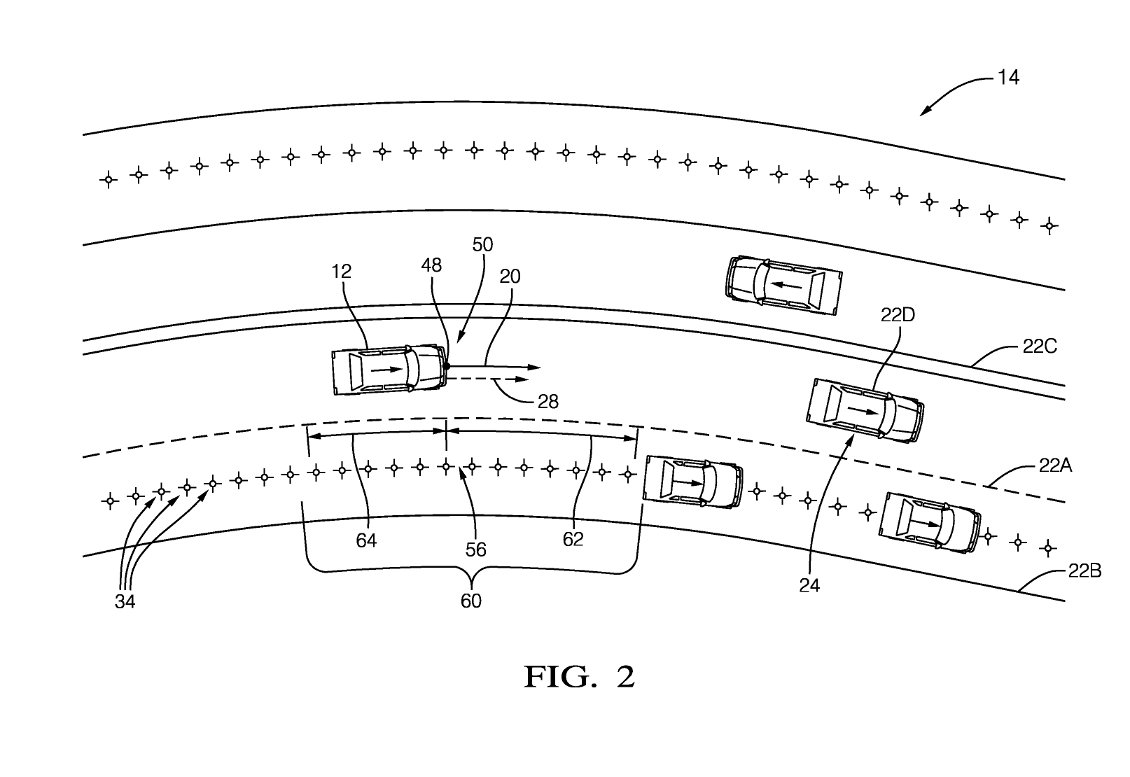

FIGS. 1 and 2 illustrate, respectively, a non-limiting example of a system 10 for automated operation of a host-vehicle 12, and a non-limiting example of a roadway 14 traveled by the host-vehicle 12. The system 10 includes an object-sensor 16 used to determine a first-polynomial 18 indicative of a preferred-steering-path 20 for steering the host-vehicle 12. In general, the first-polynomial 18 is determined based on the relative-location of one or more instances of an object 22 detected proximate to the host-vehicle 12. The object-sensor 16 may include a camera 16A useful to detect objects such as a lane-marking 22A, a roadway-edge 22B, a curb 22C, an other-vehicle 22D and/or other objects on or near the roadway 14 useful to determine where to steer the host-vehicle 12. The object-sensor 16 may also include a radar-device 16B that, as will be recognized by those in the art, may be advantageous for determining a relative-speed of and direction to the other-vehicle 22D, or other objects that are not readily detected by the camera 16A because, for example, the object has a similar color as the background. If the other-vehicle 22D is detected, the first-polynomial 18 may also be determined based on a roadway-position 24 of the other-vehicle with respect to, or relative to, the host-vehicle 12. Alternatively, or in addition to the camera 16A and/or the radar-device 16B, the object-sensor 16 may include a lidar-unit 16C to detect one or more instances of objects useful to indicate a travel-lane for the host-vehicle 12 on the roadway 14. The object-sensor may include, but is not limited to, any one or combination of the devices suggested that may be useful to detect objects for determining the first-polynomial 18.

While the example given above suggests that the first-polynomial 18 may be determined based on the roadway-position 24 of the other-vehicle 22D, which is illustrated as traveling in the same lane of the roadway 14 as the host-vehicle 12, it is contemplated that the first-polynomial 18 may be determined based on the relative positions of other vehicles on the roadway 14 such as those illustrated traveling the same direction as the host-vehicle 12 in an adjacent lane, or an approaching-vehicle traveling in an opposing-lane of the roadway 14. Determining the preferred-steering-path 20 from the first-polynomial 18 based only on roadway-position 24 of the other-vehicle 22D and/or relative positions of any other vehicles on the roadway 14 may be advantageous when fixed objects such as the lane-marking 22A are temporarily not visible (e.g. obscured by snow) or not present because the roadway 14 is under-construction.

It is expected that situations will arise when the object-sensor 16 is unable to detect suitable and/or sufficient instances of the object 22 to determine the first-polynomial 18 with enough confidence to be used for determining the preferred-steering-path 20. In order to continue or maintain automated control of the host-vehicle 12 when the object 22 is not detected, the system 10 may include a global-positioning-system-receiver, hereafter the GPS-receiver 26, that is used to determine a second-polynomial 30 indicative of an alternative-steering-path 28 based on information or data retrieved from a GPS-map 32. It is recognized that the alternative-steering-path 28 may not exactly match the preferred-steering-path 20 because of GPS-coordinate errors introduced by the GPS-receiver 26. Even high-precision versions of the GPS-receiver 26 will typically have errors of a few centimeters.

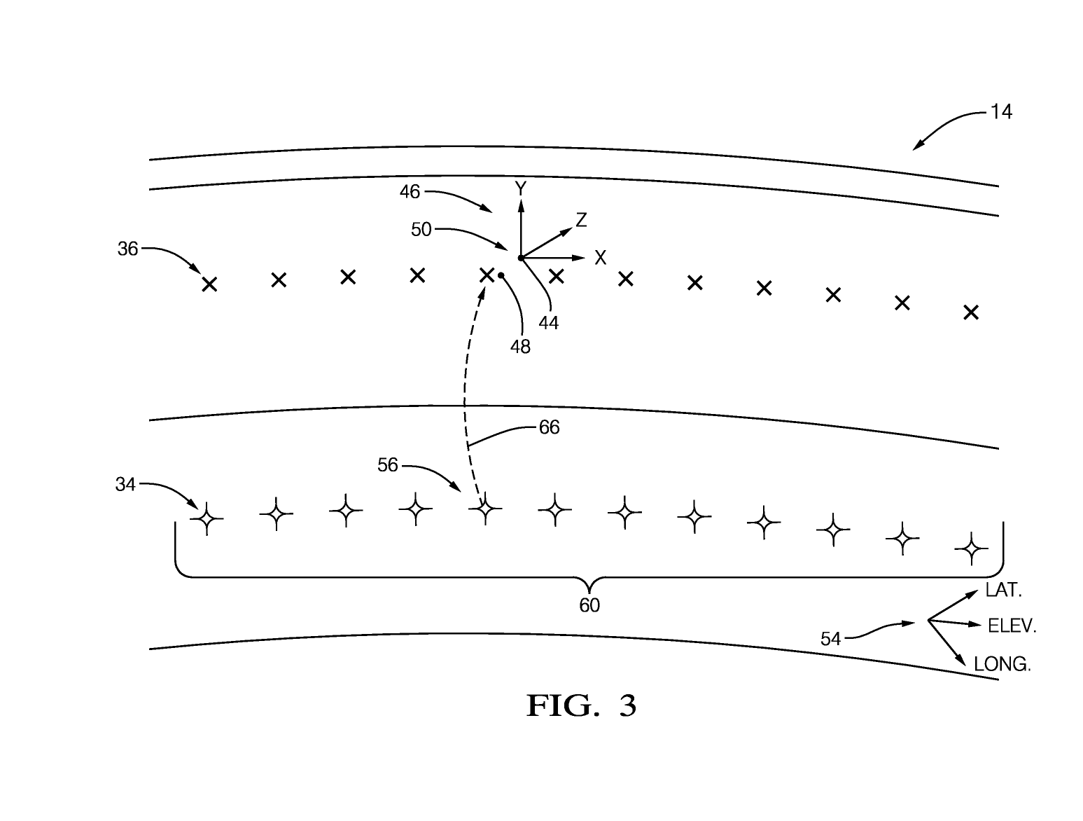

In order to minimize the cost of the system 10 is it preferable to use a lower-precision version of the GPS-receiver 26 which is expected to have errors on the order of one meter to a few meters. The differences between the preferred-steering-path 20 and the alternative-steering-path 28 may be further magnified if the GPS-map 32 does not have data for every lane of the roadway. As indicated in FIG. 2, the GPS-map 32 may only indicate one set or plurality of map-points 34 for the travel-direction of the host-vehicle 12. That is, the GPS-map 32 may not be a high-definition type map that has map-points to indicate the center of every lane of the roadway 14. If the GPS-map 32 only includes the plurality of map-points 34 illustrated in FIG. 2, those map-points need to be transformed into the vehicle-reference-frame 46. Once transformed, those transformed map-points (alternative-sequence 36, FIG. 3) may then be used to determine the second-polynomial 30 and steer the host-vehicle 12 along the alternative-steering-path 28, as will be described in more detail below.

The system 10 may also include a controller 40 configured to steer the host-vehicle 12 in accordance with the first-polynomial 18 when the object 22 is detected, and steer the host-vehicle 12 in accordance with the second-polynomial 30 when the object 22 is not detected. In other words, the host-vehicle 12 may be steered by the system 10 to follow the preferred-steering-path 20 when the first-polynomial 18 is based on a sufficient amount of information from the object-sensor 16, and follow the alternative-steering-path 28, which is based on GPS information from the GPS-receiver 26 and the GPS-map 32, when the information from the object-sensor 16 is insufficient, e.g. the object 22 is not detected. In order for the controller 40 to be prepared to transition from the first-polynomial 18 to the second-polynomial 30, perceived differences between the first-polynomial 18 and the second-polynomial 30 are monitored or determined prior to the transition so that the transition is relatively seamless, i.e. undetectable, by an occupant or operator 42 of the host-vehicle 12. That is, errors introduced by the inaccuracy of the GPS-receiver 26 need to be detected or learned so that correction factors to compensate for those errors can be learned prior to the transition.

While the host-vehicle 12 is traveling the roadway 14, and there are sufficient instances of the object 22 to steer the host-vehicle 12 along the preferred-steering-path 20, the first-polynomial 18 and the second-polynomial 30 are periodically updated as the host-vehicle 12 proceeds along the roadway 14. Updates or recalculations of the first-polynomial 18 and the second-polynomial 30 may occur according to a timer, every second for example, or may be according to distance traveled, every 10 meters for example. It is contemplated that the interval (time or distance) may be adjusted according to, but not limited to, the speed of the host-vehicle 12, the density of data in the GPS-map 32, and/or the shape of the roadway (curved vs. straight).

By performing the updating and monitoring prior to the transition, the GPS-receiver 26 and/or the GPS-map 32 can be lower-cost, lower-resolution versions because, as will be shown, resolution errors can be detected and correction factors or offsets can be determined and refined prior to the transition. That is, the alternative-steering-path 28 can be substantially matched to the preferred-steering-path 20 prior to the transition. Once the transition is made, the host-vehicle 12 can be steered by the controller 40 according to the second-polynomial 30 along the alternative-steering-path 28 because the errors due to inaccuracy of the GPS-receiver 26 and/or sparseness of data from the GPS-map 32 can be compensated. Once the object 22 (i.e. any suitable object or a sufficient number of objects) is detected, the first-polynomial 18 can again be determined and the selection of which polynomial is used may revert back to the first-polynomial 18. It is also contemplated that if some object is detected, but the detected object is not sufficient for determining the preferred-steering-path 20, the detected object could be used to validate that the alternative-steering-path 28 is close enough to what would likely be the preferred-steering-path 20 to continue steering the host-vehicle 12 along the alternative-steering-path 28.

The controller 40 may include a processor (not shown) such as a microprocessor or other control circuitry such as analog and/or digital control circuitry including an application specific integrated circuit (ASIC) for processing data as should be evident to those in the art. The controller 40 may include memory, including non-volatile memory, such as electrically erasable programmable read-only memory (EEPROM) for storing one or more routines, thresholds and captured data, such as those shown in FIG. 1. The one or more routines may be executed by the processor to perform steps for processing signals/information received by the controller 40 for steering the host-vehicle 12 as described herein.

FIG. 3 illustrates a non-limiting example of a portion of the roadway 14 with the map-points 34 and the alternative-sequence 36 shown. It is noted that the map-points 34 and the alternative-sequence 36 do not actually appear on the roadway 14. Rather, each of the markings represents a GPS-coordinate that corresponds to a specific location or point along the center of the respective travel-lanes of the roadway 14, for example. The map-points 34 are indicated or specified as a list of GPS-coordinates stored in the GPS-map, which may be stored in memory that is directly accessible by the controller 40, and/or may be accessible via a remote internet server, i.e. are stored ‘in the cloud’. The markings that form the alternative-sequence 36 are indicated in a list of coordinates referenced or measured relative to the host-vehicle 12, which were determined by transforming the map-points 34 onto the travel-lane of the host-vehicle 12 (not shown in FIG. 3 to simplify the illustration).

The process of transforming or translating the map-points 34 onto the travel-lane of the host-vehicle 12 to determine the alternative-sequence 36 may include determining various offsets, correction-factors, and/or a matrix-type transformation so the second-polynomial 30 is substantially matched to the first-polynomial 18. The various offsets, correction-factors and the transformation compensate for errors in the position reported by the GPS-receiver 26, for instances when the map-points 34 are associated with a travel-lane other than that which is occupied by the host-vehicle 12, and when the reference-frames of the host-vehicle 12 and the GPS-map 32 are not aligned. Then, if the object 22 is not detected (or an insufficient number of objects is detected) so the first-polynomial 18 can't be used to steer the host-vehicle 12, the alternative-steering-path 28 will already be substantially matched to the preferred-steering-path 20. That is, the various offsets, correction-factors, and/or transformations that have been ‘learned’ can be used to generate subsequent solutions of the second-polynomial 30 so the alternative-steering-path 28 substantially matches what would have been the preferred-steering-path 20 if the object 22 was detected. As used herein, ‘substantially matches’ means that the alternative-steering-path 28 is close enough to the preferred-steering-path 20 so that the host-vehicle 12 stays within the boundaries of the current travel-lane of the roadway 14.

By way of example and not limitation, the first-polynomial 18 may be a third-order polynomial with the general form of y=f(x)=a+b*x+c*x̂2+d*x̂3. The value of x corresponds to a distance forward of the host-vehicle 12, and the value of y indicates how much the travel-lane deviates from a straight-ahead path of the host-vehicle 12 at the distance x. For example, if the travel-lane is straight and the heading of the host-vehicle 12 matches or is aligned with the heading of the travel-lane, then b=c=d=0. If the host-vehicle 12 is precisely centered in the travel-lane at the instant the polynomial is determined, then a=0. Accordingly, if the travel-lane is straight and the host-vehicle 12 is precisely centered, then a=b=c=d=0, i.e. y=f(x)=0. If the host-vehicle 12 is centered, but the travel-lane curves to the right, then b, c, and d may have non-zero values that cause the value of y to increase as x increases.

Any combination of the lane-marking 22A, the road-edge 22B, the curb 22C, and the like (e.g. roadway walls or barriers) may be used to determine a lane-marking-path from which the first-polynomial 18 can be calculated that corresponds to the present position of the host-vehicle 12. The first-polynomial 18 may also be based on a target-vehicle-path determined by periodic measurements of the roadway-position 24 of the other-vehicle 22D. The periodic measurements determine the target-vehicle-path in a manner comparable to keeping track of its trail-points that are like dots of paint being periodically dropped on the roadway 14 by the other-vehicle 22D. Selection between the lane-marking-path and target-vehicle-path typically gives priority to the lane-marking-path. However, if lane-marking-path is not valid, target-vehicle-path will be taken into consideration.

In order to determine the first-polynomial 18, the controller 40 is configured to define an origin 44 (FIG. 3) in a vehicle-reference-frame 46 that corresponds to a reference-point 48 (FIG. 2) located at, for example, the center of the front-bumper of the host-vehicle 12. If the host-vehicle 12 and the vehicle-reference-frame 46 were shown on the same drawing, the origin 44 would align with the reference-point 48. The host-vehicle 12 and the vehicle-reference-frame 46 are not shown on the same drawing only for the purpose of simplifying the drawings. It follows that the initializing solution of the first-polynomial 18, y=f(x=0)=a, is measured laterally relative to the reference-point 48. Given ‘a’, the remaining coefficients are solved using known mathematical techniques to determine the first-polynomial 18 based on a relative-position of the object 22 (or multiple objects) relative to the reference-point 48.

The second-polynomial 30 may also be a third-order polynomial similar to that described above for the first-polynomial 18, and is generally fit to the alternative-sequence 36 which is derived from map-points 34 from the GPS-map 32. To select or retrieve data from the GPS-map 32, the controller 40 uses information or signals from the GPS-receiver 26 to determine a GPS-location 50 that, for example, corresponds to the reference-point 48 of the host-vehicle 12. The GPS-location 50 is generally based on a vehicle-coordinate 52 from the GPS-receiver 26. Conceptually, the controller 40 determines where on the GPS-map 32 the host-vehicle 12 is ‘located’. As will be recognize by those in the art, the vehicle-coordinate 52 may be expressed in terms of global longitude, latitude, and elevation. As such, the vehicle-coordinate 52 is measured or expressed relative to a world-reference-frame 54 (i.e. a position or location on a globe representative of the earth). It is noted that the world-reference-frame 54 is independent and is typically not aligned with the vehicle-reference-frame 46.

If the vehicle-reference-frame 46 is characterized by x, y, and z coordinates, where the x-coordinates correspond to a longitudinal-axis (e.g. forward/rearward) of the host-vehicle 12, the y-coordinates correspond to a lateral-axis (e.g. left/right) of the host-vehicle 12, and the z-coordinates correspond to a vertical-axis (e.g. up/down); and the world-reference-frame 54 is characterized by global coordinates of latitude, longitude, and elevation, where changes in latitude correspond to North/South movement; changes in longitude correspond to East/West movement, and changes in elevation correspond to up/down movement, then the only instance when the vehicle-reference-frame 46 is aligned with the world-reference-frame 54 is when the host-vehicle 12 is traveling due North where the longitudinal axis points North, the lateral axis points East, and the vertical axis points up.

In order to select an appropriate set of data from the GPS-map 32 to form the alternative-sequence 36, the controller 40 may first select from the plurality of map-points 34 in the GPS-map 32 a match-point 56 that ‘pairs’ with the reference-point 48. As used herein, to select the match-point 56 that pairs with the reference-point 48 generally means to select from the plurality of map-points 34 a point that is the closest to the reference-point 48, and corresponds to a travel-lane that is representative (e.g. indicates the same lane or another lane parallel to and having the same general travel direction) of the travel-lane of the host-vehicle 12. By way of example and not limitation, the match-point 56 may be characterized simply as which one of the plurality of map-points 34 is nearest or closest to the GPS-location 50. Alternatively, the controller 40 may be configured to determine a heading 58 of a host-vehicle 12 based on two or more of the vehicle-coordinates 52 from the GPS-receiver 26. The match-point 56 may then be selected as the one being located in a direction perpendicular to the heading 58 with respect to the GPS-location 50.

The controller 40 may then retrieve or designate a point-sequence 60 from the plurality of map-points 34. The point-sequence 60 is generally characterized as those map-points of the plurality of map-points 34 that are aligned with the match-point 56 and within a forward-distance 62 and a rearward-distance 64 of the match-point 56. By way of example and not limitation, a suitable value for the forward-distance 62 is one-hundred meters (100 m), and a suitable value for the rearward-distance 64 is fifty meters (50 m). It is contemplated that these values may, for example, be increased as the speed of the host-vehicle 12 increases or if the roadway 14 is particularly straight. The showing of the alternative-sequence 36 as being repositioned relative to the point-sequence 60 is only for illustrative purposes. It is noted that the second-polynomial 30 could be solved by ‘viewing’ the point-sequence 60 from the match-point 56 to determine the ‘shape’ of the curve indicated by the point-sequence 60. It also noted that the matching-error may then understood to be a comparison of the shape of the second-polynomial 30 to the shape of the first-polynomial 18 which is ‘viewed’ from the reference-point 48, rather than actually overlying the second-polynomial 30 determine by the alternative-sequence 36 over the first polynomial 18.

The controller 40 may then determine a transformation 66 (e.g. a matrix-type transformation) effective to align the match-point 56 with a reference-point 48 on the host-vehicle 12, and align the world-reference-frame 54 with a vehicle-reference-frame 46 of the host-vehicle 12. Matrix based mathematical techniques to shift the point-sequence 60 as suggested by the illustration of the transformation 66 in FIG. 3 to create the alternative-sequence 36 are known. Also, techniques to re-orient the world reference-frame 54 of the point-sequence 60 so the alternative-sequence 36 is referenced to the vehicle-reference-frame 46 are known. That is, the alternative-sequence 36 is determined by applying the transformation 66 to the point-sequence 60. Following the transformation 66, the second-polynomial 30 can be determined based on the alternative-sequence 36 in in a similar manner as is used to determine the first-polynomial 18.

In some circumstances where, for example, the roadway 14 is straight and errors in the GPS-location 50 indicated by the GPS-receiver are relatively small, less than a half-meter (0.5 m) for example, the initial solution for the second-polynomial 30 provided by the transformation 66 may be sufficiently accurate to be used to determine the alternative-steering-path 28. However, if the roadway 14 is curved so that the radius of a curve indicated by the plurality of map-points 34 is different from the radius of the travel-lane occupied by the host-vehicle 12 in FIG. 2 (i.e. indicated by the alternative-sequence 36), and/or the errors in the GPS-location 50 indicated by the GPS-receiver are relatively large, greater than a half-meter (0.5 m) for example, it may be possible to improve the fit or matching of the second-polynomial 30 to the first-polynomial 18 by applying additional shifts or offsets to the second-polynomial 30 and checking how well the second-polynomial 30 fits or matches the first-polynomial 18.

To check the fit or matching of the alternative-steering-path 28 to the preferred-steering-path 20, the controller 40 may be further configured to determine a matching-error 68 based on an area, a difference, or a discrepancy between the first-polynomial 18 and the second-polynomial 30 over a distance interval defined by the rearward-distance 64 and the forward-distance 62. If the matching-error 68 is deemed to be too great, greater than some predetermined error-threshold for example, the controller 40 may determine a longitudinal-offset 70 and a lateral-offset 72 for the second-polynomial 30 relative to the first-polynomial 18 effective to reduce the matching-error 68. Initial values for the longitudinal-offset 70 and the lateral-offset 72 may be predetermined or numerically selected using an algorithm to ‘steer’ the value of the matching-error to a minimum. Also, the longitudinal-offset 70 and the lateral-offset 72 may be incremented/applied together or independently. That is, the longitudinal-offset 70 and/or the lateral-offset 72 may be applied to the second-polynomial 30, and the matching-error 68 recalculated. The process of incrementally increasing or decreasing the longitudinal-offset 70 and/or the lateral-offset 72 may be continued until a minimized value of the matching-error 68 is calculated, or the matching-error 68 is less than the error-threshold, i.e. is close enough. Once preferred values of the longitudinal-offset 70 and the lateral-offset 72 are determined that provide for a sufficiently low error-threshold, those values of the longitudinal-offset 70 and the lateral-offset 72 can be applied when the second-polynomial 30 is used to determine the alternative-steering-path 28 for steering the host-vehicle 12 when the object 22 is not detected.

To further improve the fit or matching of the alternative-steering-path 28 to the preferred-steering-path 20, the controller 40 may be further configured to determine the heading 58 of a host-vehicle 12 as described above, and determine an angle-offset 74 for the second-polynomial 30 relative to the first-polynomial 18 effective to reduce the matching-error 68. As above, the angle-offset 74 may be incrementally increased or decreased and the matching-error 68 recalculated until a sufficient small value of the matching-error 68 is calculated. This incrementing/decrementing of the angle-offset 74 may be done independently of or in combination with the incremental increasing/decreasing the longitudinal-offset 70 and/or the lateral-offset 72 described above. Alternatively, instead of using a predetermined value for an initial value of the angle-offset 74, the controller 40 may be configured to determine the heading 58 of a host-vehicle 12 based on vehicle-coordinates 52 from the GPS-receiver 26, and determine the angle-offset 74 for the second-polynomial based on the heading 58.

By way of further explanation, the initial matching and rough alignment serves to retrieve the point-sequence 60 from the GPS-map 32, which is referenced to the world-reference-frame 54, and transforms the point-sequence 60 into the vehicle-reference-frame 46. After the initial matching, the point-sequence 60 becomes the alternative-sequence 36. The second-polynomial 30 is calculated based on the alternative-sequence 36. The second-polynomial 30 may be incrementally adjusted by applying the longitudinal-offset 70, the lateral-offset 72, and/or the angle-offset 74 until the matching error 68 between the first-polynomial 18 (based on a detected instance of the object 22) and the second polynomial 30 is minimized or less than the error-threshold.

The process described above can be visualized by visualizing the first-polynomial 18 (based on a detected instance of the object 22) as being drawn on a sheet of paper, and the second-polynomial 30 (based on data from the GPS-map 32) as being drawn on a sheet of clear-film overlying the sheet of paper. The clear-film illustrated with second-polynomial 30 is incrementally adjusted (i.e. massaged or ‘wiggled about’) relative to the paper illustrated with the first-polynomial 18 until the matching-error 68 (e.g. the area or the sum-of squared errors, or other method to determine a difference or discrepancy between the first-polynomial 18 and the second-polynomial 30) is minimized or less than the error-threshold.

Once the transformation 66 and the various offsets described above are learned or determined to minimize the discrepancy between the first-polynomial 18 and the second-polynomial 30, the system 10 is prepared steer the vehicle along the alternative-steering-path 28 based on the second-polynomial 30. As long as sufficient instances of the object 22 are available to steer along the preferred-steering-path 20, the transformation 66 and various offsets are continuously or periodically updated so that the system 10 remains prepared to make the transition from the preferred-steering-path 20 to the alternative-steering-path 28. Once the transition is made, the transformation 66 and the various offsets (the longitudinal-offset 70, the lateral-offset 72, and/or the angle-offset 74) can't be updated unless an instance of the object 22 is detected. However, the transformation 66 and various offsets can be used to update the second-polynomial 30 as the host-vehicle 12 progresses along the roadway 14. As the host-vehicle 12 proceeds, a new instance of the match-point 56 may be identified so that which of the plurality of map-points 34 is selected to form the point-sequence 60. This updated instance of the point-sequence 60 is then transformed by the previously determined transformation and adjusted according to the previously determined offsets to define an updated alternative-sequence from which the second-polynomial 30 can be updated. By this process the system 10 can continue to steer the host-vehicle 12 according to GPS data.

Instead of or in addition to calculating the matching-error 68 described above, the controller 40 may be further configured to determine a correlation-coefficient 76 based on a comparison of the first-polynomial 18 and the second-polynomial 30, or based on a comparison of the preferred-steering-path 20 and the alternative-steering-path 28. The correlation-coefficient 76 may be determined using any of many known ways to measure correlation of data or samples of formulas, such as a sum of squared errors. The controller 40 may then steer the host-vehicle 12 in accordance with the second-polynomial 30, i.e. follow the alternative-steering-path 28, only when the correlation-coefficient 76 is greater than a correlation-threshold 78, which may be a stored, predetermined value, or may be varied in accordance with, for example, vehicle speed and/or curvature of the roadway 14.

In order for the controller 40 to be able steer the host-vehicle 12 along the preferred-steering-path 20 or the alternative-steering-path 28, the system 10 includes a vehicle-control device 80 operable to control one or more of acceleration, braking, and steering of the host-vehicle 12. Multiple configurations of the vehicle-control device 80 are contemplated. For example, in one configuration the steering-wheel 82 may rotate as the controller 40 varies the steering direction of the host-vehicle 12. In this case, the system 10 may be configured so the operator 42 could physically overcome the intent of the controller 40 via the manual-controls 84.

Alternatively, the host-vehicle 12 may not have a steering-wheel or any means for the operator 42 to influence the steering direction of the host-vehicle 12. That is, the host-vehicle 12 may be configured to operate in a fully-automated or autonomous mode where the operator 42 of the host-vehicle 12 cannot influence the manual-controls 84 that control acceleration, braking, or steering of the host-vehicle 12, so the controller 40 may have total or absolute control of the manual-controls 84. As another alternative, the vehicle-control device 80 may include a control-override 86 be able to decouple the steering-wheel 82 from the steering mechanism that controls the steering direction of the host-vehicle 12 and thereby override any attempt by the operator 42 to influence or otherwise steer the host-vehicle 12.

The control-override 86 of the vehicle-control device 80 may include one or more of an accelerator-control device 90 operable to over-ride operation of an accelerator-pedal 88 by the operator 42 of the host-vehicle 12; a brake-control device 92 operable to over-ride operation of a brake-pedal 94 by the operator 42 of the host-vehicle 12; and a steering-control device 96 operable to over-ride operation of a steering-wheel 82 by the operator 42 of the host-vehicle 12. The system 10 may also include a warning-device 98 that can be activated to notify the operator that the system 10 is unable to steer the host-vehicle 12 along the alternative-steering-path 28 because, for example, the correlation-coefficient 76 is greater than the correlation-threshold 78 and a suitable instance of the object 22 has not been detected, so the operator 42 should assume manual control of the host-vehicle 12.

Accordingly, a system 10 for automated operation of a host-vehicle 12 and a controller 40 for the system 10 are provided. Features of the system 10 and the controller 40 described herein make it possible for the host-vehicle 12 to be equipped with a lower precision version of the GPS-receiver 26 than would be expected to be necessary for steering the host-vehicle 12 when the object sensor 16 does not detect a suitable instance of the object 22 (or multiple instances of the object 22) for steering the host-vehicle 12. The system 10 and controller 40 achieve this advantage by ‘learning’ correction-factors (e.g. the transformation 66, the longitudinal-offset 70, the lateral-offset 72, and/or the angle-offset 74) necessary to minimize the matching-error 68 when a curve or shape that corresponds to the second-polynomial 30 overlies or is aligned with a potentially different curve or shape that corresponds to the first-polynomial 18 while suitable instances of the object 22 are detected. Then, when suitable instances of the object 22 are not detected, the system 10 and controller 40 can reliably steer the host-vehicle 12 using only data/information from the GPS-receiver 26 and the GPS-map 32. In other words, the learned transformation is remembered and used to adjust the second-polynomial 30 during the interval of time where the first-polynomial isn't available.

While this invention has been described in terms of the preferred embodiments thereof, it is not intended to be so limited, but rather only to the extent set forth in the claims that follow.

We claim:

1. A system for automated operation of a host-vehicle, said system comprising:
an object-sensor used to determine a first-polynomial indicative of a preferred-steering-path, said first-polynomial determined based on an object detected proximate to a host-vehicle;
a global-positioning-system-receiver (GPS-receiver) used to determine a second-polynomial indicative of an alternative-steering-path, said second-polynomial determined based on a GPS-map; and
a controller configured to steer the host-vehicle in accordance with the first-polynomial when the object is detected, and steer the host-vehicle in accordance with the second-polynomial when the object is not detected.

2. The system in accordance with claim 1, wherein the object-sensor includes a camera; and
the first-polynomial is determined based on one or more of a lane-marking, a curb, and a roadway edge.

3. The system in accordance with claim 1, wherein the object-sensor includes a radar-device; and
the first-polynomial is determined based on a roadway-position of an other-vehicle.

4. The system in accordance with claim 1, wherein the controller is configured to define an origin in a vehicle-reference-frame that corresponds to a reference-point on the host-vehicle; and
determine the first-polynomial based on a relative-position of the object relative to the reference-point.

5. The system in accordance with claim 1, wherein the controller is configured to determine a GPS-location of a reference point of the host-vehicle; said GPS-location indicated relative to a world-reference-frame;
select a match-point from a plurality of map-points on the GPS-map in the world-reference-frame that pairs with the GPS-location;
retrieve a point-sequence from the plurality of map-points, said point-sequence characterized as those map-points that are aligned with the match-point and within a forward-distance and a rearward-distance of the match-point;
determine a transformation effective to associate the match-point with the reference-point and align the world-reference-frame with a vehicle-reference-frame of the host-vehicle; and
determine an alternative-sequence in the vehicle-reference-frame by applying the transformation to the point-sequence in the world-reference-frame;
determine the second-polynomial based on the alternative-sequence.

6. The system in accordance with claim 5, wherein the match-point is characterized as that one of the plurality of map-points that is nearest to the GPS-location.

7. The system in accordance with claim 5, wherein the controller is configured to determine a heading of a host-vehicle based on vehicle-coordinates from the GPS-receiver, and
the match-point characterized as being located in a direction perpendicular to the heading with respect to the GPS-location.

8. The system in accordance with claim 5, wherein the controller is configured to determine a matching-error based on a discrepancy between the first-polynomial and the second-polynomial over a distance between the rearward-distance and the forward-distance; and
determine a longitudinal-offset and a lateral-offset for the second-polynomial relative to the first-polynomial effective to reduce the matching-error, wherein subsequent second-polynomial and matching-error determinations include the longitudinal-offset and the lateral-offset.

9. The system in accordance with claim 8, wherein the controller is configured to determine a heading of a host-vehicle based on vehicle-coordinates from the GPS-receiver, and
determine an angle-offset for the second-polynomial relative to the first-polynomial effective to reduce the matching-error, wherein subsequent second-polynomial and matching-error determinations include the angle-offset.

10. The system in accordance with claim 5, wherein the controller is configured to determine a heading of a host-vehicle based on vehicle-coordinates from the GPS-receiver, and
determine an angle-offset for the second-polynomial based on the heading.

11. The system in accordance with claim 1, wherein the controller is further configured to determine a correlation-coefficient based on a comparison of the first-polynomial and the second-polynomial, and steer the host-vehicle in accordance with the second-polynomial only when the correlation-coefficient is greater than a correlation-threshold.

12. The system in accordance with claim 1, wherein the controller is configured to define an origin in a vehicle-reference-frame that corresponds to a reference-point on the host-vehicle;
determine the first-polynomial based on a relative-position of the object relative to the reference-point;
determine a GPS-location and a heading of the host-vehicle based on a vehicle-coordinates from the GPS-receiver, said vehicle-coordinates measured relative to a world-reference-frame;
select from a plurality of map-points on the GPS-map a match-point that pairs with the reference-point;
retrieve a point-sequence from the plurality of map-points, said point-sequence characterized as those map-points that are aligned with and within a forward-distance and a rearward-distance of the match-point;
determine a transformation effective to align the match-point with a reference-point on the host-vehicle and align the world-reference-frame with the vehicle-reference-frame; and
determine an alternative-sequence by applying the transformation to the point-sequence;
determine a second-polynomial indicative of an alternative-steering-path based on the alternative-sequence.

13. The system in accordance with claim 12, wherein the controller is configured to determine a matching-error based on a discrepancy between the first-polynomial and the second-polynomial over a distance between the rearward-distance and the forward-distance;
determine a longitudinal-offset and a lateral-offset for the second-polynomial relative to the first-polynomial effective to reduce the matching-error; and
determine an angle-offset for the second-polynomial relative to the first-polynomial effective to reduce the matching-error.

14. The system in accordance with claim 12, wherein the match-point is characterized as which one of the plurality of map-points that is nearest to the GPS-location.

15. The system in accordance with claim 12, wherein the match-point characterized as being located in a direction perpendicular to the heading with respect to the GPS-location.
